(19) United States
(12) Patent Application Publication
(10) Pub. No.: US 2026/0316868 A1
(43) Pub. Date: Oct. 15, 2026

(54) LAMP COWL

(71) Applicant: SUZUKI MOTOR CORPORATION, Hamamatsu-shi (JP)

(72) Inventor: Kyoma SUZUKI, Hamamatsu-shi (JP)

(73) Assignee: SUZUKI MOTOR CORPORATION, Hamamatsu-shi (JP)

(21) Appl. No.: 19/573,559

(22) Filed: Mar. 20, 2026

(30) Foreign Application Priority Data
Apr. 11, 2025 (JP) 2025-065738

(51) Int. Cl. B62J 17/04; B62J 17/10

(52) U.S. Cl. CPC B62J 17/04; B62J 17/10

(57) ABSTRACT

A lamp cowl including a windscreen installed on top, the lamp cowl configured to cover at least an upper part of a headlamp, the lamp cowl includes: an exterior part having an opening configured to expose a lens surface of the headlamp; and an interior part configured to cover at least an upper part of the lens surface at a position inserted into the opening of the exterior part. The interior part is formed with an air guide passage configured to guide traveling wind to a rear side of the windscreen.

### CROSS-REFERENCE TO RELATED APPLICATIONS

This application is based on and claims priority under 35 USC 119 from Japanese Patent Application No. 2025-065738 filed on Apr. 11, 2025, the entire content of which is incorporated herein by reference.

### Technical Field

The present invention relates to a lamp cowl.

### Background Art

Some saddle-ride type vehicles are equipped with cowls or windscreens to protect a rider from traveling wind, but negative pressure generated behind the windscreen can cause discomfort to the rider. For this reason, an air guide port is provided between a lower center of the windscreen and an upper center of a lamp cowl (see, for example, Patent Literature 1). In a structure of Patent Literature 1, a recess is provided in the upper center of the lamp cowl, and an air guide port is formed by a lower edge of the windscreen and the recess in the lamp cowl. By taking in traveling wind through the air guide port, generation of negative pressure behind the windscreen is reduced.

### Citation LIst

### Patent Literature

Patent Literature 1: JP2013-193649A

However, while a structure of Patent Literature 1 reduces discomfort felt by a rider due to negative pressure, the air guide port is exposed to exterior of the vehicle, which degrades design and causes a problem such as a foreign object entering through the air guide port hitting the rider.

### SUMMARY

The present invention has been made in consideration of these points, and an object of the present invention is to provide a lamp cowl that can suppress generation of negative pressure on a rear side of a windscreen, prevent deterioration of design, and protect a rider from a foreign object.

A lamp cowl according to an aspect of the present invention is a lamp cowl that includes a windscreen installed on top, and the lamp cowl configured to cover at least an upper part of a headlamp, the lamp cowl including: an exterior part having an opening configured to expose a lens surface of the headlamp; and an interior part configured to cover at least an upper part of the lens surface at a position inserted into the opening of the exterior part, where the interior part is formed with an air guide passage configured to guide traveling wind to a rear side of the windscreen.

According to the lamp cowl of the aspect of the present invention, the traveling wind is guided to the rear side of the windscreen by the air guide passage, thereby alleviating negative pressure on the rear side of the windscreen and reducing discomfort to a rider. Since the air guide passage extends from a position inserted into the opening of the exterior part, an inlet of the air guide passage is not conspicuous, improving design of a vehicle body. Furthermore, the traveling wind passing through the inside of the lamp cowl cools an electrical component inside the lamp cowl and also makes it difficult for a foreign object that has entered the air guide passage to be directed toward the rider.

### BRIEF DESCRIPTION OF DRAWINGS

FIG. 1 is a perspective view of a front part of a vehicle according to an example.

FIG. 2 is a front view of the front part of the vehicle according to the example.

FIG. 3 is a cross-sectional view of the front part of the vehicle of FIG. 2 taken along a line A-A.

FIG. 4 is a cross-sectional view of the front part of the vehicle of FIG. 2 taken along a line B-B.

FIG. 5 is a cross-sectional view of the front part of the vehicle of FIG. 2 taken along a line C-C.

FIG. 6 is a cross-sectional view of the front part of the vehicle of FIG. 2 taken along a line D-D.

### DESCRIPTION OF EMBODIMENTS

A lamp cowl according to an aspect of the present invention has a windscreen installed on top and covers at least an upper part of a headlamp. An opening is formed in an exterior part of the lamp cowl to expose a lens surface of the headlamp, and at least an upper part of the lens surface is covered by an interior part of the lamp cowl at a position inserted into the opening of the exterior part. An air guide passage is formed in the interior part to guide traveling wind to a rear side of the windscreen, and the air guide passage guides the traveling wind to the rear side of the windscreen, thereby alleviating negative pressure on the rear side of the windscreen and reducing discomfort to a rider. Since the air guide passage extends from the position inserted into the opening of the exterior part, an inlet of the air guide passage is not conspicuous, improving design. Furthermore, the traveling wind passing through the inside of the lamp cowl cools an electrical component inside the lamp cowl and also makes it difficult for a foreign object that has entered the air guide passage to be directed toward the rider.

### Example

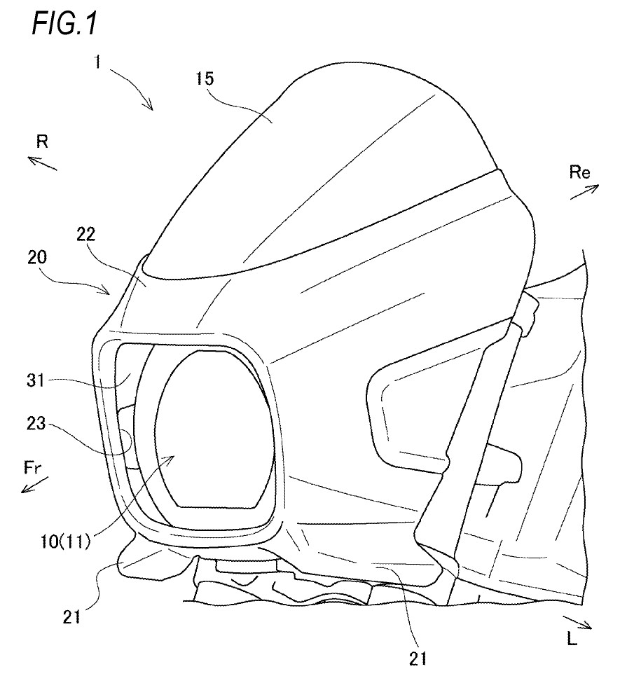

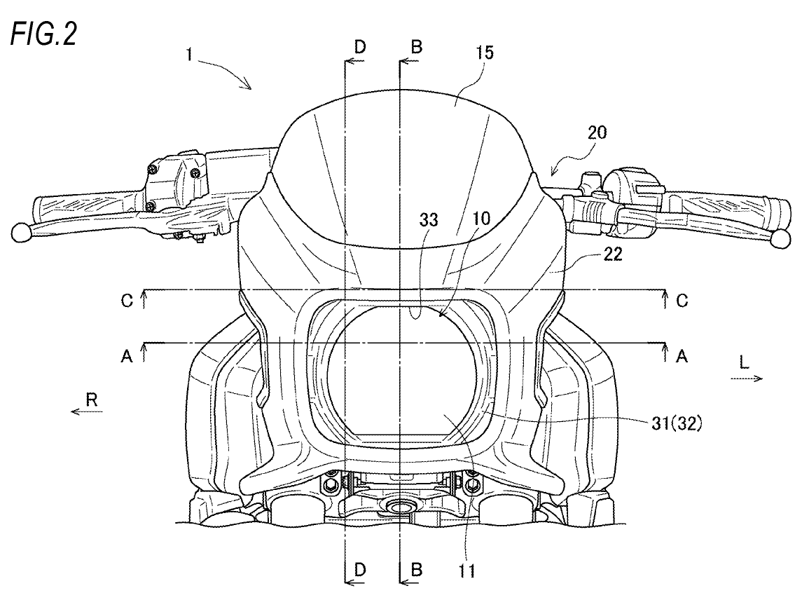

A saddle-ride type vehicle equipped with a lamp cowl according to this example will be described with reference to the accompanying drawings. FIG. 1 is a perspective view of a front part of the vehicle according to this example. FIG. 2 is a front view of the front part of the vehicle according to this example. In the following drawings, an arrow Fr indicates the front of the vehicle, an arrow Re indicates the rear of the vehicle, an arrow L indicates the left side of the vehicle, and an arrow R indicates the right side of the vehicle. Also, a handlebar is not illustrated in FIG. 1.

As illustrated in FIG. 1, a lamp cowl 20 that covers a periphery of a headlamp 10 is provided at a front part of a saddle-ride type vehicle 1. A windscreen 15 is provided on an upper portion of the lamp cowl 20, and extends obliquely upward and rearward above the headlamp 10. The lamp cowl 20 and the windscreen 15 are connected together to form a streamlined shape at the front part of the vehicle. A pair of winglets 21 protrude outward in a vehicle width direction from a lower portion of the lamp cowl 20. A downforce of the pair of winglets 21 pushes down a vehicle body, increasing a ground contact force of a front wheel (not illustrated).

The lamp cowl 20 has a double structure made up of an outer cowl (exterior part) 22 that reduces external influences and an inner cowl (interior part) 31 that supports an internal structure. An opening 23 having a rounded rectangular shape is formed in a front surface of the outer cowl 22 to expose a lens surface 11 having a circular shape of the headlamp 10. The inner cowl 31 covers a periphery of the lens surface 11 at a position inserted into the opening 23 of the outer cowl 22. That is, the lens surface 11 is located one step rearward of an opening edge of the outer cowl 22, and the inner cowl 31 fills a gap between the opening edge of the outer cowl 22 and an outer peripheral edge of the lens surface 11.

In general saddle-ride type vehicles, airflow may separate behind the windscreen, creating negative pressure. When turbulence is created by the negative pressure behind the windscreen, irregular wind pressure is applied to rider's helmet and body, and wind noise around the helmet is amplified, causing discomfort to the rider. To reduce negative pressure, a windscreen is often provided with an air guide port, but the air guide port degrades the design and may allow a foreign object to pass through. Therefore, in this example, traveling wind is guided to a rear side of the windscreen from a location inside the opening in the outer cowl, thereby reducing generation of negative pressure.

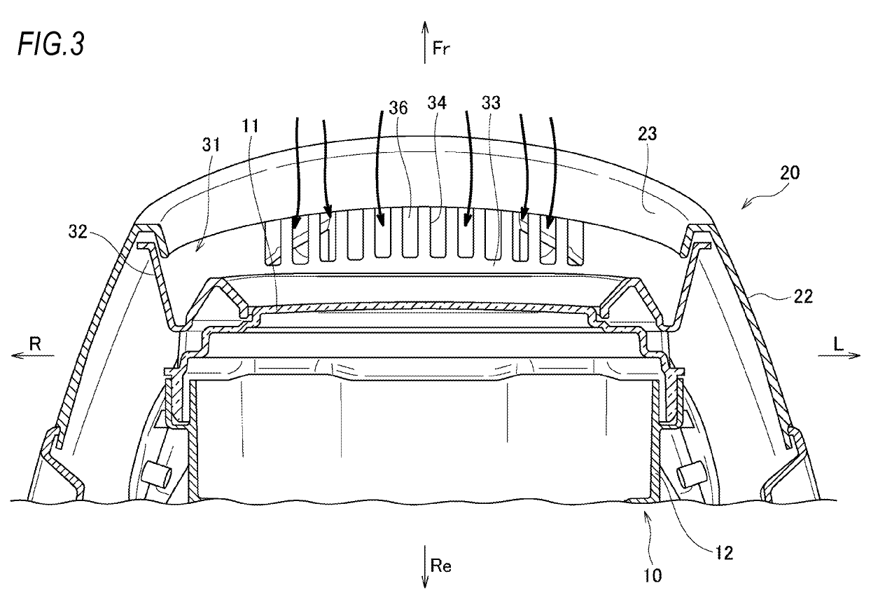

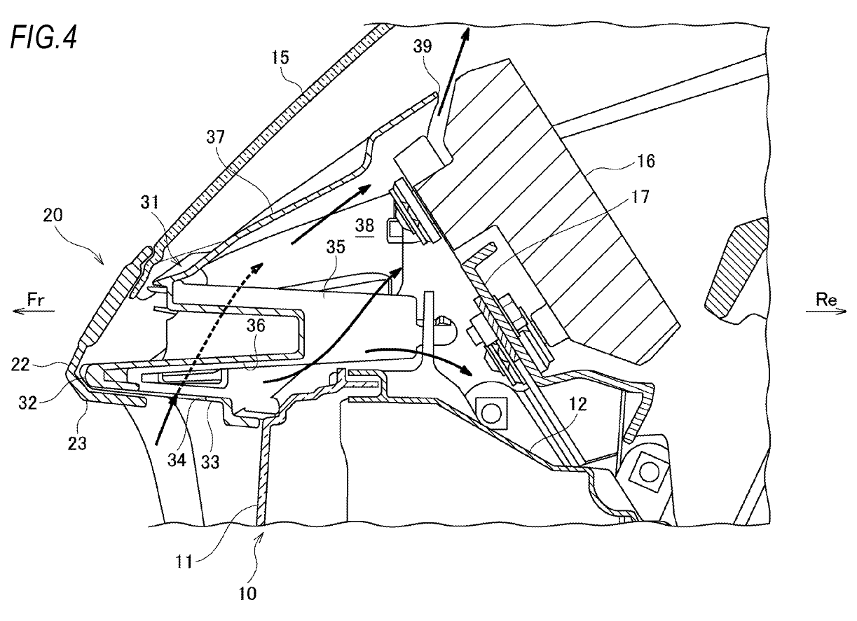

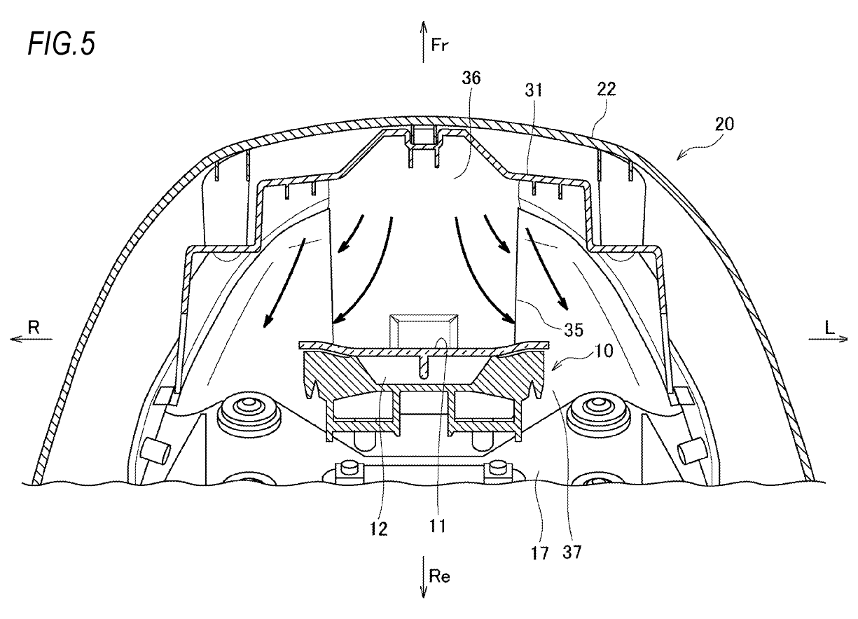

The lamp cowl will be described with reference to FIGS. 2 to 5. FIG. 3 is a cross-sectional view of the front part of the vehicle of FIG. 2 taken along a line A-A. FIG. 4 is a cross-sectional view of the front part of the vehicle of FIG. 2 taken along a line B-B. FIG. 5 is a cross-sectional view of the front part of the vehicle of FIG. 2 taken along a line C-C.

As illustrated in FIGS. 2 and 3, the outer cowl 22 of the lamp cowl 20 is an exterior component that covers the periphery of the headlamp 10, and a spindle shape of the outer cowl 22 reduces air resistance and improves the design of the vehicle body. The inner cowl 31 of the lamp cowl 20 is installed inside the outer cowl 22, and an annular portion of the inner cowl 31 exposed from the opening 23 of the lamp cowl 20 serves as a lens holder 32 that surrounds the headlamp 10. An outer edge of the lens holder 32 fits into a folded portion of the opening edge of the outer cowl 22, and an inner edge of the lens holder 32 is in contact with the lens surface 11 of the headlamp 10.

As illustrated in FIGS. 3 and 4, the inner cowl 31 is formed with an air guide passage that guides the traveling wind to a rear side of the windscreen 15. More specifically, the lens holder 32 protrudes like an eave from an upper edge of the lens surface 11 of the headlamp 10, and an inlet of the air guide passage is formed on a protruding surface 33 of the lens holder 32. Since the protruding surface 33 of the lens holder 32 is in a blind spot, the inlet of the air guide passage is not conspicuous, improving the design of the vehicle body. The inlet of the air guide passage is formed by a plurality of slits 34 arranged in the vehicle width direction, and the plurality of slits 34 allow traveling wind to flow while preventing intrusion of foreign objects such as dust.

As illustrated in FIGS. 4 and 5, an upper portion of the lens holder 32 of the inner cowl 31 protrudes rearward, and the protruding portion of the inner cowl 31 forms a case support portion 35 that supports a lamp case 12 of the headlamp 10. The case support portion 35 is positioned above the plurality of slits 34, and a diffusion wall 36 is formed below the case support portion 35 to diffuse the traveling wind in the air guide passage in the vehicle width direction. A part of the air guide passage is blocked by the diffusion wall 36, and the traveling wind is blown against the diffusion wall 36 and diffused in the vehicle width direction, making it difficult for a foreign object such as dust to travel along the air guide passage and reach the rider.

A meter cover 37 extends obliquely upward and rearward from the case support portion 35 of the inner cowl 31 along a rear surface of the windscreen 15. A meter panel 17 that supports a meter unit 16 is installed behind the meter cover 37, and the meter panel 17 extends obliquely downward and rearward from near a rear end of the meter cover 37. Therefore, downstream of the plurality of slits 34, a diffusion chamber 38 that is partitioned by the meter cover 37 and the meter panel 17 and has a triangular shape in a side view extends. As the traveling wind enters the diffusion chamber 38 through the plurality of slits 34, the force of the traveling wind is reduced and noise energy is attenuated.

Between the meter cover 37 and the meter unit 16, a discharge port 39 having a slit shape that is long in the vehicle width direction is formed as an outlet of the air guide passage. The discharge port 39 is positioned so as to face a rear side of the windscreen 15. By discharging the traveling wind to the rear side of the windscreen 15, a pressure difference between a high pressure area on a front side of the windscreen 15 and a low pressure area on a rear side of the windscreen 15 is alleviated. This reduces the negative pressure behind the windscreen 15, reducing the rider's discomfort. Furthermore, a gap is provided between the meter panel 17 and the headlamp 10, and electrical components such as the headlamp 10 and the meter unit 16 are exposed to the traveling wind, thereby cooling the electrical components.

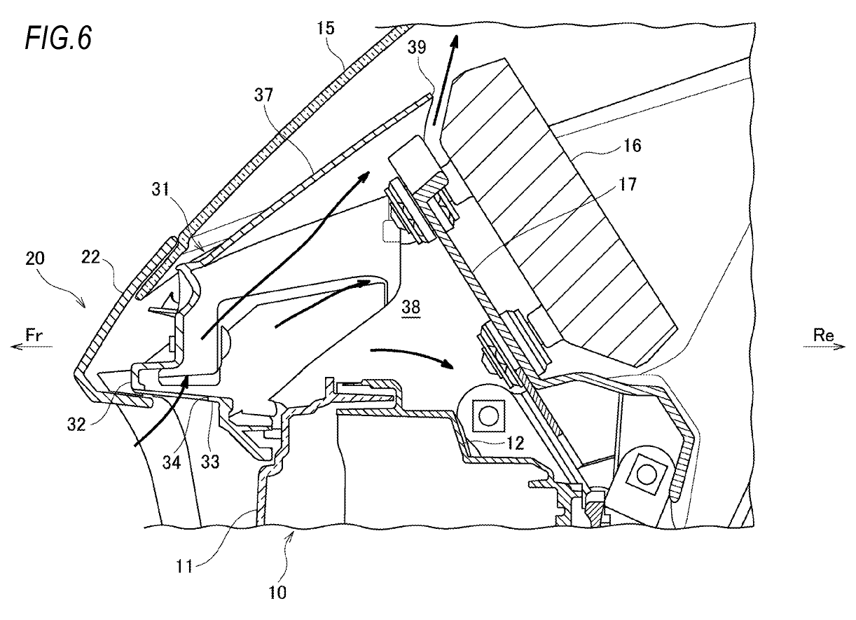

The flow of traveling wind within the inner cowl will be described with reference to FIGS. 3 to 6. FIG. 6 is a cross-sectional view of the front part of the vehicle of FIG. 2 taken along a line D-D.

As illustrated in FIG. 3, the plurality of slits 34 are arranged in the vehicle width direction on the protruding surface 33 of the lens holder 32. A front end of the protruding surface 33 of the lens holder 32 is inserted into the folded portion of the opening edge of the outer cowl 22. Therefore, when the plurality of slits 34 are viewed from above, the plurality of slits 34 on the rear side of the outer cowl 22 are in a blind spot, and when the plurality of slits 34 are viewed from the front, the plurality of slits 34 on a far side of the folded portion of the outer cowl 22 are in a blind spot (see FIG. 2). This allows the traveling wind to be taken into the inner cowl 31 without impairing the design of the front part of the vehicle.

The plurality of slits 34 extend in the front-rear direction, and the traveling wind is divided into fine streams that follow the linear shapes of the plurality of slits 34. The slit 34 at the center in the vehicle width direction when viewed from below overlaps with the diffusion wall 36, and the traveling wind flows through the slit 34 at the center in the vehicle width direction toward the diffusion wall 36. When viewed from below, the slits 34 on both ends in the vehicle width direction are out of contact with the diffusion wall 36, and the traveling wind enters spaces to the sides of the diffusion wall 36 through the slits 34 on both ends in the vehicle width direction. In this way, the diffusion wall 36 is interposed in the air guide passage extending from some of the plurality of slits 34 to the discharge port 39.

As illustrated in FIGS. 4 and 5, when traveling wind is taken in through the slit 34 at the center in the vehicle width direction, the traveling wind is blown onto the diffusion wall 36 and diffused along the wall surface. The traveling wind travels around the diffusion wall 36 (case support portion 35) from the side, the force of the traveling wind is reduced in the diffusion chamber 38, and the traveling wind is discharged from the discharge port 39 to the rear side of the windscreen 15. In this way, the inside of the inner cowl 31 has a labyrinth structure, making it difficult for even a small foreign object that can pass through the slits 34 to reach the rider. Part of the traveling wind travels through the diffusion chamber 38 and is used to cool the headlamp 10 and the meter unit 16.

As illustrated in FIGS. 5 and 6, when traveling wind is taken in through the slits 34 on both ends in the vehicle width direction, the traveling wind passes through the sides of the diffusion wall 36 and flows directly into the diffusion chamber 38. At both ends in the vehicle width direction, the diffusion chamber 38 is wider than at the center in the vehicle width direction because the case support portion 35 is not present. The traveling wind flows toward the discharge port 39 without passing through the diffusion wall 36, but the force of the traveling wind is greatly reduced in the diffusion chamber 38, and a small foreign object that would pass through the slit 34 is prevented from flying out of the discharge port 39. Furthermore, part of the traveling wind is diffused in the diffusion chamber 38 and used to cool the headlamp 10 and the meter unit 16.

As illustrated in FIGS. 4 and 6, the discharge port 39 is formed by the meter cover 37 and the meter unit 16. The discharge port 39 is formed in the shape of a slit extending in the vehicle width direction, and the discharge port 39 faces the rear side of the windscreen 15. In this case, the windscreen 15 extends obliquely upward and rearward, and the traveling wind is discharged obliquely upward and rearward from the discharge port 39, and an angle formed by an extension direction of the windscreen 15 and a discharge direction of the traveling wind from the discharge port 39 is an acute angle. The traveling wind discharged from the discharge port 39 flows easily along the rear surface of the windscreen 15, and separation of the airflow on the rear surface side of the windscreen 15 is reduced, suppressing the generation of negative pressure.

As described above, according to the lamp cowl 20 of this example, the traveling wind is guided to the rear side of the windscreen 15 by the air guide passage within the inner cowl 31, thereby alleviating the negative pressure on the rear side of the windscreen 15 and reducing discomfort to the rider. Since the air guide passage extends from a position inserted into the opening 23 of the outer cowl 22, the inlet of the air guide passage is not conspicuous, improving the design of the vehicle body. Furthermore, the traveling wind passes through the inside of the lamp cowl 20, thereby cooling the electrical components inside the lamp cowl 20 and preventing a foreign object that has entered the air guide passage from heading toward the rider.

In this example, the outer cowl and the inner cowl are formed as separate bodies, but the outer cowl and the inner cowl may be formed as an integral body. That is, the lamp cowl may be formed from a single member, and the exterior part, interior part, diffusion wall, and inclined wall may be formed on the lamp cowl of the single member.

In addition, in this example, the lamp cowl covers the periphery of the headlamp, but the lamp cowl may be formed so as to cover at least an upper part of the headlamp.

Furthermore, in this example, the interior part covers the periphery of the lens surface, but it is sufficient that the interior part is formed so as to cover at least the upper part of the lens surface.

Furthermore, in this example, the inlet of the air guide passage is formed on the protruding surface that protrudes from the upper edge of the lens surface, but the inlet of the air guide passage may be formed in a position that allows the traveling wind from a location inside the exterior part to be taken in to the inside of the inner cowl. For example, the inlet of the air guide passage may be formed on a protruding surface that protrudes from a side edge of the lens surface.

Furthermore, in this example, the outlet of the air guide passage is formed between the rear end of the meter cover and the meter unit, but the outlet of the air guide passage may be formed in a position facing the rear side of the windscreen. For example, the outlet of the air guide passage may be formed by a slit provided in the meter cover.

Furthermore, the lamp cowl installation structure of this example is not limited to the saddle-ride type vehicle described above, and may be adopted in other types of saddle-ride type vehicles. The term "saddle-ride type vehicle" is not limited to all vehicles in which a rider sits astride a seat, but also includes scooter-type vehicles in which a rider does not sit astride a seat.

As described above, a first aspect is a lamp cowl (20) that has a windscreen (15) installed on top and covers at least an upper part of a headlamp (10), the lamp cowl including an exterior part (outer cowl 22) having an opening (23) for exposing a lens surface (11) of the headlamp and an interior part (inner cowl 31) that covers at least an upper part of the lens surface at a position inserted into the opening of the exterior part, where the interior part is formed with an air guide passage for guiding traveling wind to a rear side of the windscreen. According to this configuration, the traveling wind is guided to the rear side of the windscreen by the air guide passage, and negative pressure on the rear side of the windscreen is alleviated, thereby reducing discomfort to a rider. Since the air guide passage extends from a position inserted into the opening of the exterior part, an inlet of the air guide passage is not conspicuous, improving design of a vehicle body. Furthermore, the traveling wind passing through the inside of the lamp cowl cools an electrical component inside the lamp cowl and also makes it difficult for a foreign object that has entered the air guide passage to be directed toward the rider.

In a second aspect, in the first aspect, an inlet of the air guide passage is formed on a protruding surface (33) that protrudes in an eave shape from an upper edge of the lens surface, and an outlet of the air guide passage is formed at a position facing the rear side of the windscreen. According to this configuration, the protruding surface is in a blind spot, so the inlet of the air guide passage is not conspicuous, improving design of the vehicle body. The traveling wind is guided from the upper edge of the lens surface to the rear side of the windscreen, thereby alleviating the negative pressure on the rear side of the windscreen.

In a third aspect, in the first or second aspect, an inlet of the air guide passage is formed in a slit shape. This configuration allows traveling wind to pass through while preventing a foreign object from entering.

In a fourth aspect, in any one of the first to third aspects, the interior part is formed with a diffusion wall (36) for diffusing the traveling wind in the air guide passage in a vehicle width direction. According to this configuration, the traveling wind is blown against the diffusion wall and diffused in the vehicle width direction, making it difficult for a foreign object such as dust to travel along the air guide passage and reach the rider.

In a fifth aspect, in any one of the first to fourth aspects, the interior part is formed with an inclined wall (meter cover 37) extending along a rear surface of the windscreen, and an outlet of the air guide passage is formed between a rear end of the inclined wall and a meter unit. According to this configuration, the traveling wind passes above the lamp unit and in front of the meter unit and is discharged to the rear side of the windscreen. This allows the meter unit, lamp unit, or the like to be cooled by the traveling wind while suppressing generation of negative pressure on the rear side of the windscreen.

Although the present example is described, other examples may be made by combining the above-described example and modification examples in whole or in part.

Furthermore, the technology of the present invention is not limited to the above-described example, and may be variously changed, substituted, or modified within the scope that does not deviate from the spirit and intent of the technical idea. Furthermore, when the technical idea can be realized in a different way due to technological advances or derived other technologies, it may be implemented using that method. Therefore, the claims cover all embodiments that may fall within the scope of the technical concept.

1. A lamp cowl including a windscreen installed on top, the lamp cowl configured to cover at least an upper part of a headlamp, the lamp cowl comprising:
an exterior part having an opening configured to expose a lens surface of the headlamp; and
an interior part configured to cover at least an upper part of the lens surface at a position inserted into the opening of the exterior part,
wherein the interior part is formed with an air guide passage configured to guide traveling wind to a rear side of the windscreen.

2. The lamp cowl according to claim 1,
wherein an inlet of the air guide passage is formed on a protruding surface that protrudes in an eave shape from an upper edge of the lens surface, and
wherein an outlet of the air guide passage is formed at a position facing the rear side of the windscreen.

3. The lamp cowl according to claim 1, wherein an inlet of the air guide passage is formed in a slit shape.

4. The lamp cowl according to claim 1, wherein the interior part is formed with a diffusion wall configured to diffuse the traveling wind in the air guide passage in a vehicle width direction.

5. The lamp cowl according to claim 1,
wherein the interior part is formed with an inclined wall extending along a rear surface of the windscreen, and
wherein an outlet of the air guide passage is formed between a rear end of the inclined wall and a meter unit.
